(19) United States
(12) Patent Application Publication
(10) Pub. No.: US 2020/0020059 A1
(43) Pub. Date: Jan. 16, 2020

(54) SYSTEM FOR DETECTING AND REMEDIATING INVALID DOMAIN NAME REGISTRATION REQUESTS

(71) Applicant: Bank of America Corporation, Charlotte, NC (US)

(72) Inventors: Donald Joseph Cardinal, Celina, TX (US); Christopher Daniel Birch, Dayton, OH (US); Shane Edward Asher, San Antonio, TX (US); Travis John Hicks, Cedar Park, TX (US)

(73) Assignee: Bank of America Corporation, Charlotte, NC (US)

(21) Appl. No.: 16/034,060

(22) Filed: Jul. 12, 2018

(51) Int. Cl. G06Q 50/18; G06Q 10/10; H04L 29/12

(52) U.S. Cl. CPC G06Q 50/184; H04L 61/3025; H04L 61/2046; G06Q 10/10

(57) ABSTRACT

A system for detecting and remediating invalid domain name registration requests typically includes a processor, a memory, and an analysis resolution module stored in the memory. The analysis module is typically configured for: receiving a brand submission comprising a brand identifier from a brand custodian; validating the brand submission; storing a brand validation record in a brand database; receiving a domain name registration request for a domain name; comparing the domain name to the brand identifier; determining that the domain name comprises the brand identifier or an imitation of the brand identifier; in response to determining that the domain name comprises the brand identifier or the imitation of the brand identifier, transmitting a notification to the brand custodian; receiving a response to the notification from the brand custodian; and based on the response to the notification from the brand custodian, rejecting or approving the domain name registration request.

### FIELD OF THE INVENTION

The present invention embraces a system for detecting and remediating invalid domain name registration requests that is typically configured for: receiving a brand submission comprising a brand identifier from a brand custodian; validating the brand submission; storing a brand validation record in a brand database; receiving a domain name registration request for a domain name; comparing the domain name to the brand identifier; determining that the domain name comprises the brand identifier or an imitation of the brand identifier; in response to determining that the domain name comprises the brand identifier or the imitation of the brand identifier, transmitting a notification to the brand custodian; receiving a response to the notification from the brand custodian; and based on the response to the notification from the brand custodian, rejecting or approving the domain name registration request.

### BACKGROUND

As the use, size, and importance of the Internet has increased, particularly in commerce, the use of invalid domain names has grown. Accordingly, a need exists for an improved way of way of preventing and remediating the use of invalid domain names.

### SUMMARY

In one aspect, the present invention embraces a system, and an associated method and computer program product, for detecting and remediating invalid domain name registration requests. The system typically includes a computer processor, a memory, and a network communication device. The system also typically includes an analysis module stored in the memory and executable by the processor. In one embodiment, the analysis module is configured to perform the following steps: receiving a brand submission from a brand custodian, the brand submission comprising a brand identifier; validating the brand submission; in response to validating the brand submission, storing a brand validation record in a brand database, the brand validation record comprising the brand identifier; receiving a domain name registration request for a domain name; comparing the domain name to the brand identifier; in response to comparing the domain name to the brand identifier, determining that the domain name comprises the brand identifier or an imitation of the brand identifier; in response to determining that the domain name comprises the brand identifier or the imitation of the brand identifier, transmitting a notification to the brand custodian; receiving a response to the notification from the brand custodian; and based on receiving the response to the notification from the brand custodian, rejecting or approving the domain name registration request.

In a particular embodiment, the response comprises an approval from the brand custodian. The domain name registration request may be approved in response to receiving the approval from the brand custodian.

In another particular embodiment, the response comprises a rejection from the brand custodian. The domain name registration request may be rejected in response to receiving the rejection from the brand custodian.

In another particular embodiment, validating the brand submission is based on analyzing documentary evidence provided by the brand custodian.

In another particular embodiment, validating the brand submission comprises determining that the brand custodian uses the brand identifier.

In another particular embodiment, validating the brand submission comprises determining that the brand custodian owns the brand identifier.

In another particular embodiment, the analysis module is further configured to perform the steps of: receiving a second domain name registration request for a second domain name; comparing the second domain name to the brand identifier; in response to comparing the domain name to the brand identifier, determining that the second domain name does not comprises or imitate the brand identifier; and in response to determining that the domain name does not comprise or imitate the brand identifier, approving the domain name registration request.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts an operating environment in accordance with an aspect of the present invention;

FIG. 2 schematically depicts a system for detecting and remediating invalid domain name registration requests in accordance with an aspect of the present invention; and

FIG. 3 depicts a method of detecting and remediating invalid domain name registration requests in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

An “entity” may be any person or organization. An entity may be a domain name registrar, a brand custodian, or a requesting entity. A domain name registrar is an organization that manages the registration of Internet domain names. A domain name is used to identify a particular domain on the Internet. Domain names are often used to identify websites of various entities. A domain name registrar typically permits other entities to register and use domain names.

A “brand identifier” refers to any identifier that may be used to identify an entity or a brand of such entity. A brand identifier may be a name, trade name, trademark, service mark, slogan, logo, domain name, or the like that identifies an entity or a brand (e.g., product or service) of the entity. A brand identifier is typically managed by a “brand custodian.” The brand custodian may be the owner of the brand identifier. Alternatively, the brand custodian may be a third party that a brand owner has authorized to manage, maintain, and/or use a particular brand identifier.

As the use, size, and importance of the Internet has increased, particularly in commerce, the use of invalid domain names has grown. An “invalid domain name” is a domain name that utilizes or mimics a name, brand, trademark, or other identifier of an entity, but is not authorized to do so by such entity. In this regard, an invalid domain name may be employed to convince an Internet user that a website identified by such invalid domain name is associated with a particular entity, even though such invalid domain name actually is not associated with such particular entity. The entity operating the invalid domain name may use the invalid domain name to commit misappropriation against visitors or may use or mimic a brand identifier of a brand custodian in order to benefit from the goodwill that such brand custodian has built in the brand identifier.

In order to remediate the use of invalid domain names, brand custodians may manually monitor the registration of new domain names to identify potentially invalid domain names. If the brand custodian identifies a registration of an invalid domain name, the brand custodian then may contact the applicable domain name registrar to request deactivation of the invalid domain name or transfer of the invalid domain name to the brand custodian. However, this process of remediating invalid domain names is problematic. In this regard, identifying invalided domain names and then working with the applicable domain name registrar regarding the deactivation and/or transfer of the invalid domain name often causes brand custodian to expend considerable resources (e.g., time, effort, money, and the like). Accordingly, a need exists for an improved way of way of preventing and remediating the use of invalid domain names.

To address these problems, the present invention is directed to a system for proactively detecting and remediating domain name registration requests for invalid domain names. The system typically receives and validates submissions of brand identifiers from brand custodians. Based on the submitted brand identifiers, the system then typically automatically monitors registration requests to identify domain names that may include or mimic a submitted brand identifier. If a domain name includes or mimics a submitted brand identifier, the system then typically notifies the applicable brand custodian and then provides the brand custodian with an opportunity to reject the registration request for such domain name.

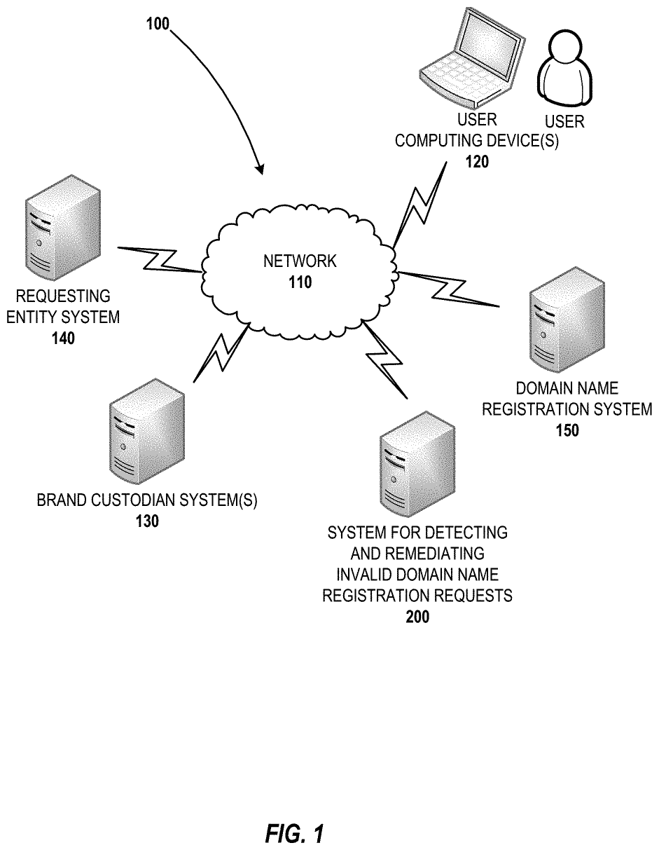

FIG. 1 provides a block diagram illustrating an operating environment 100, in accordance with an embodiment of the present invention. As illustrated in FIG. 1, the operating environment 100 typically includes one or more domain name registration systems. In this regard, FIG. 1 depicts a domain name registration system 150. Each domain name registration system is typically operated by a domain name registrar and it typically configured to process domain name registration requests.

The operating environment 100 also typically includes a system 200 for detecting and remediating invalid domain name registration requests. As described in more detail herein, the system 200 is typically configured to determine whether a domain name that an entity is requesting to register includes or imitates a brand identifier of a brand custodian. The system 200 may be operated by the domain name registrar that operates the domain name registration system 150. Alternatively, the system 200 may be operated by a different entity. In some embodiments, the system 200 and the domain name registration system 150 are part of the same system. In other embodiments, the system 200 and the domain name registration system 150 are different systems.

The operating environment 100 also typically includes one or more brand custodian systems 130 and at least one requesting entity system 140. The one or more brand custodian systems 130 may be operated by one or more brand custodians and may provide the system 200 with information regarding one or more brand identifiers of such brand custodians. Each requesting entity system 140 is typically operated by a requesting entity and is typically used to submit a domain name registration request to a domain name registration system (e.g., the domain name registration system 150). As used herein, a “requesting entity” is an entity other than a brand custodian that attempts to register a domain name, such as an invalid domain name, for use.

The system 200, the domain name registration system 150, the at least one requesting entity system 140, and the one or more brand custodian systems 130 are typically in communication with one another over a network 110, such as the Internet, wide area network, local area network, Bluetooth network, near field network, or any other form of contact or contactless network. In addition, one or more users (e.g., employees of a domain name registrar), each having a user computing device 120, such as a PC, laptop, mobile phone, tablet, television, mobile device, or the like, may be in communication with the system 200 via the network 110.

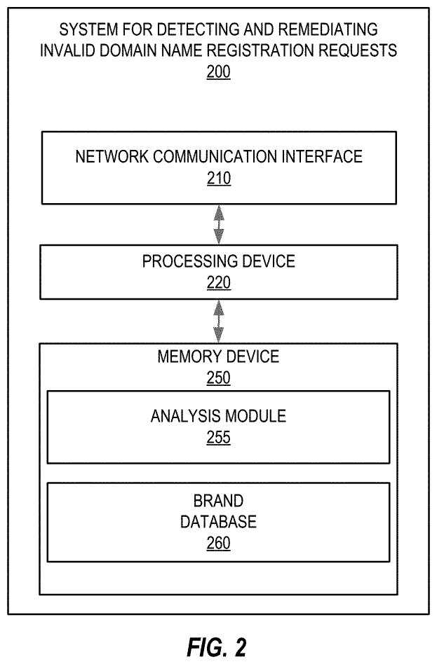

FIG. 2 depicts the system 200 for detecting and remediating invalid domain name registration requests in more detail. As depicted in FIG. 2, the system 200 typically includes various features such as a network communication interface 210, a processing device 220, and a memory device 250. The network communication interface 210 includes a device that allows the system 200 to communicate with the domain name registration system 150, the at least one requesting entity system 140, the one or more brand custodian systems 130, and user computing devices 120 (e.g., over the network 110 (shown in FIG. 1)).

As used herein, a “processing device,” such as the processing device 220, generally refers to a device or combination of devices having circuitry used for implementing the communication and/or logic functions of a particular system. For example, a processing device 220 may include a digital signal processor device, a microprocessor device, and various analog-to-digital converters, digital-to-analog converters, and other support circuits and/or combinations of the foregoing. Control and signal processing functions of the system are allocated between these processing devices (e.g., processors) according to their respective capabilities. The processing device 220 may further include functionality to operate one or more software programs based on computer-executable program code thereof, which may be stored in a memory. As the phrase is used herein, a processing device 220 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 250, generally refers to a device or combination of devices that store one or more forms of computer-readable media for storing data and/or computer-executable program code/instructions. Computer-readable media is defined in greater detail below. For example, in one embodiment, the memory device 250 includes any computer memory that provides an actual or virtual space to temporarily or permanently store data and/or commands provided to the processing device 220 when it carries out its functions described herein.

As noted, the system 200 is configured to detect and remediate invalid domain name registration requests. Accordingly, the system 200 typically includes one or more modules stored in the memory device 250, which facilitate such detection and remediation of invalid domain name registration requests. As depicted in FIG. 2, the system 200 typically includes an exception resolution module 255 configured to detect and remediate invalid domain name registration requests. To facilitate the detection of invalid domain name registration requests, the system 200 typically maintains a brand database 260 that includes data records of brand identifiers. That brand identifiers stored in the brand database 260 may be compared against domain name registration requests to determine if any such requests constitute invalid domain name registration requests.

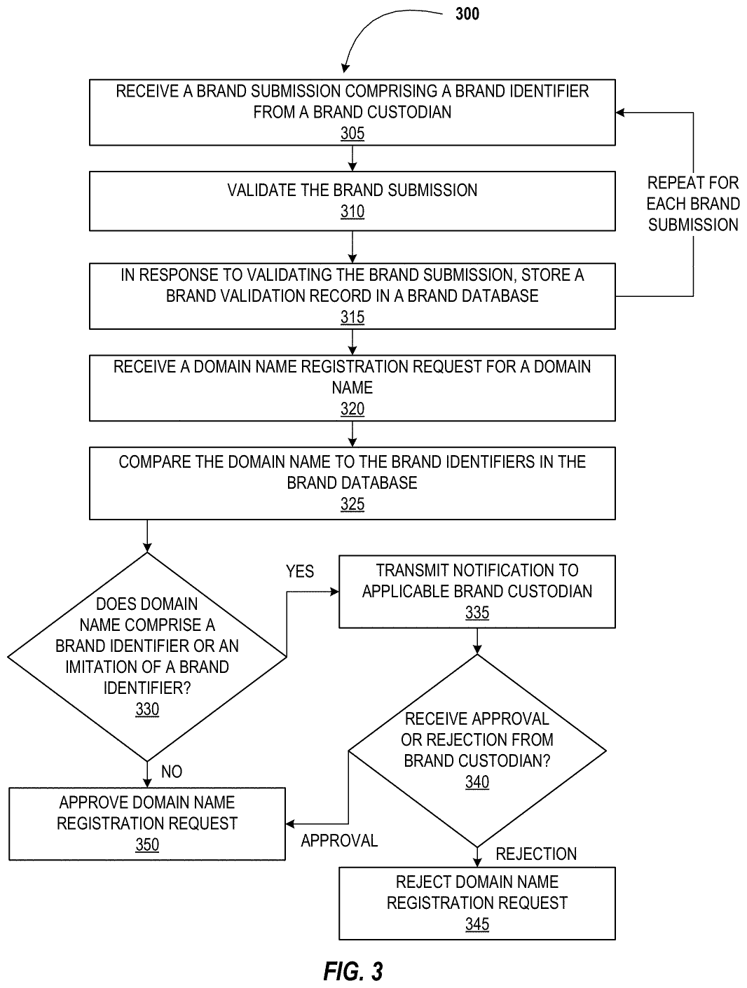

Referring now to FIG. 3, a method 300 is provided for detecting and remediating invalid domain name registration requests. This method 300 may be performed by the system 200.

At block 305, the method 300 includes receiving a brand submission from a brand custodian. The brand submission typically includes a brand identifier. The brand identifier may be a trade name, trademark, service mark, slogan, logo, domain name, or the like that the brand custodian uses to identify the brand custodian or identify products or services that the brand custodian provides. The brand custodian typically submits the brand identifier to the system 200, which may be operated by a domain registrar. To facilitate receipt of the brand submission, the system 200 may be configured to provide an Internet-accessible portal or other interface through which the brand custodian may provide the brand submission to the system 200.

In addition to including the brand identifier, the brand submission may include information related to the brand custodian's (or other authorized entity's) use of the brand identifier, such as the length of time in which the brand identifier has been in use, the types of products and/or services with which the brand identifier may be used, and/or evidence related to use of the brand identifier. The brand submission may include evidence or other information related to the brand custodian's ownership of the brand identifier. Where the brand identifier is registered with a governmental entity (e.g., a governmental trademark office) or non-governmental entity (e.g., a domain name registrar), or where an application for registration has been filed, the brand submission may include information about the registration of such brand identifier, such as a registration number.

Next, at block 310, the system 200 typically validates the brand submission. Validation of the brand submission typically includes evaluating the brand submission based on defined validation criteria.

In some embodiments, evaluating the brand submission based on defined validation criteria may include confirming that the brand custodian owns the brand identifier. For example, where the brand custodian has registered (or applied for registration) for the brand identifier, databases available from governmental or nongovernmental entities may be searched (e.g., by the system 200) to confirm that the brand custodian owns the registration (or application for registration) of the brand identifier. In some instances, documentary evidence provided with the brand submission may be analyzed to confirm the brand custodian's ownership of the brand identifier.

In some embodiments, evaluating the brand submission based on defined validation criteria may include confirming that the brand custodian uses the brand identifier. For example, evidence provided by the brand custodian may be analyzed to confirm that brand custodian uses the brand identifier, such as on the brand custodian's website or in connection with products or services offered by the brand custodian.

In some embodiments, the validation criteria may require that brand custodian have registered the brand identifier with a governmental or nongovernmental entity. For example, the validation criteria may require that the brand custodian have registered the brand identifier as a domain name with a domain registrar or as a trademark with a governmental trademark office.

In some embodiments, validation of the brand submission may be entirely automated and performed by the system 200. In other embodiments, validation of the brand submission may be at least partially performed manually (e.g., by an employee of the entity operating the system 200). In this regard, once the system 200 receives the brand submission, the system 200 may prompt a user (e.g., an employee of the entity operating the system 200) to at least partially evaluate the brand submission based on the validation criteria. The system 200 may prompt such user to perform such evaluation by transmitting a notification to a computing device (e.g., the computing device 120) of the user. For example, the system 200 may prompt a user to evaluate evidence of ownership or user that a brand custodian includes with the brand submission. The user may then inform the system 200 whether the brand submission meets the brand criteria.

In response to validating the brand submission (e.g., by confirming that the brand submission meets the validation criteria), then at block 315, the system 200 typically stores a brand validation record in a brand database. The brand validation record is typically a data record that includes information about the brand submission, such as the brand identifier, the name of the brand custodian, and/or contact information for the brand custodian, as well as an indication that the brand submission was validated. In some instances, the brand validation record may include the entire brand submission submitted by the brand custodian.

If the brand submission does not meet the validation criteria or otherwise cannot be validated, then the system 200 may inform the brand custodian that the brand identifier could not be validated. Additionally, if the brand submission does not meet the validation criteria, then the system 200 typically refrains from storing an applicable brand validation record.

The system 200 may repeat these steps (e.g., the steps described with respect to blocks 305-315) related to the validation of a brand submission for additional brand submissions, which may be submitted by the same brand custodian and/or by different brand custodians.

Subsequently, at block 320, the system 200 receives a domain name registration request. In this regard, the domain name registration request typically specifies a domain name that a requesting entity desires to register. In some embodiments (e.g., where the system 200 and the domain name registration system 150 are part of the same system), the system 200 may receive the domain name registration request directly from the requesting entity. In other embodiments (e.g., where the system 200 and the domain name registration system 150 are different systems or operated by different entities), the requesting entity may submit the domain name registration request to the domain name registration system 150, which then forwards the domain name registration request to the system 200.

At block 325, the system 200 typically compares the requested domain name to the brand validation records in the brand database. In other words, the system 200 typically compares the requested domain name to the brand identifiers that have been previously validated and, consequently, are stored in the brand database.

This comparison is typically performed to determine whether the requested domain name includes or imitates (e.g., mimics) a validated brand identifier. In this regard, the system 200 may employ defined search criteria to search the brand database to identify validated brand identifiers that may be included in or imitated by the requested domain name. For example, if a validated brand identifier of a particular brand custodian is “CompanyXYZ,” then the requested domain name “CompanyXYZ-Sales.com” may be deemed to include such validated brand identifier. Such search criteria may include rules for determining if a requested domain name does not identically include but nevertheless imitates a validated brand identifier. In this regard, if a requesting entity intends to imitate an existing brand identifier, such requesting entity may slightly vary the existing brand identifier when requesting a domain name. Such variations may include removing, adding, or varying individual characters; adding a word to the brand identifier, or employing a different top level domain. For example, if a validated brand identifier of a particular brand custodian is “ProductXYZ.biz,” then a requesting entity may attempt to mimic such brand identifier by requesting to register “PrOductXYZ.biz” and/or “ProductXYZ.org.”

If, at block 330, the requested brand identifier includes a validated brand identifier or an imitation of a validated brand identifier, then, at block 350, the system 200 typically approves the domain name registration request. If the system 200 and the domain name registration system 150 are different systems, the system 200 may transmit an approval notification to the domain name registration system 150.

If, at block 330, the requested brand identifier includes a validated brand identifier or an imitation of a validated brand identifier, then, at block 335, the system 200 typically transmits a notification to the brand custodian of such validated brand identifier. Such notification typically informs the applicable brand custodian that another entity has attempted to register a domain name that includes or may imitate such validated brand identifier. The notification may also request that the applicable brand custodian approve or reject the domain name registration request.

At block 340 the system 200 receives an approval or rejection from the applicable brand custodian. If the system 200 receives an approval from the applicable brand custodian, then, at block 350, the system 200 typically approves the domain name registration request. In this regard, the applicable brand custodian may review the domain name registration and determine that, in the brand custodian's opinion, the requested domain name is sufficiently different from the validated brand identifier. Alternatively, the applicable brand custodian may approve the domain name registration request because the applicable brand custodian had previously authorized the requesting entity to register the requested domain name.

However, if the system 200 receives a rejection from the applicable brand custodian, then, at block 345, the system 200 typically rejects the domain name registration request. Where the system 200 and the domain name registration system 150 are different systems, the system 200 may transmit a rejection notification to the domain name registration system 150, which may then notify the requesting entity of the rejection. If the system 200 and the domain name registration system 150 are part of the same system, the system 200 may notify the requesting entity of the rejection.

In some embodiment, if the system 200 does not receive an approval or rejection from the applicable brand custodian within a defined time period, the system 200 may automatically reject the domain name registration request. Alternatively, if the system 200 does not receive an approval or rejection from the applicable brand custodian within a defined time period, the system 200 may automatically approve the domain name registration request.

The system 200 may repeat these steps (e.g., the steps described with respect to blocks 320-350) related to the approval or rejection of a domain name registration request for additional requests, which may be submitted by the same requesting entity and/or by a different requesting entity.

As evident from the preceding description, the system described herein represents an improvement in technology by providing an improved way of way of preventing and remediating the use of invalid domain names. In particular, the system provides a technical solution to the Internet-centric problem of avoiding invalid domain names by providing a system for proactively detecting and remediating domain name registration requests for domain names that may be invalid. By proactively detecting and remediating domain name registration requests for domain names that may be invalid as described herein, brand custodians may avoid employing resource-intensive processes for reactively identifying and remediating invalid domain names.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for detecting and remediating invalid domain name registration requests, comprising:
one or more computer processors;
a memory;
a network communication device; and
an analysis module stored in the memory, executable by the one or more computer processors, and configured to perform the steps of:
receiving a brand submission from a brand custodian, the brand submission comprising a brand identifier;
validating the brand submission;
in response to validating the brand submission, storing a brand validation record in a brand database, the brand validation record comprising the brand identifier;
receiving a domain name registration request for a domain name;
comparing the domain name to the brand identifier;
in response to comparing the domain name to the brand identifier, determining that the domain name comprises the brand identifier or an imitation of the brand identifier;
in response to determining that the domain name comprises the brand identifier or the imitation of the brand identifier, transmitting a notification to the brand custodian;
receiving a response to the notification from the brand custodian; and
based on receiving the response to the notification from the brand custodian, rejecting or approving the domain name registration request.

2. The system according to claim 1, wherein the response comprises an approval from the brand custodian.

3. The system according to claim 2, wherein the domain name registration request is approved in response to receiving the approval from the brand custodian.

4. The system according to claim 1, wherein the response comprises a rejection from the brand custodian.

5. The system according to claim 4, wherein the domain name registration request is rejected in response to receiving the rejection from the brand custodian.

6. The system according to claim 1, wherein validating the brand submission is based on analyzing documentary evidence provided by the brand custodian.

7. The system according to claim 1, wherein validating the brand submission comprises determining that the brand custodian uses the brand identifier.

8. The system according to claim 1, wherein validating the brand submission comprises determining that the brand custodian owns the brand identifier.

9. The system according to claim 1, wherein the analysis module is further configured to perform the steps of:
receiving a second domain name registration request for a second domain name;
comparing the second domain name to the brand identifier;
in response to comparing the domain name to the brand identifier, determining that the second domain name does not comprises or imitate the brand identifier; and
in response to determining that the domain name does not comprise or imitate the brand identifier, approving the domain name registration request.

10. A computer program product for detecting and remediating invalid domain name registration requests, the computer program product comprising a non-transitory computer-readable storage medium having computer-executable instructions for causing a computer processor to perform the steps of:
receiving a brand submission from a brand custodian, the brand submission comprising a brand identifier;
validating the brand submission;
in response to validating the brand submission, storing a brand validation record in a brand database, the brand validation record comprising the brand identifier;
receiving a domain name registration request for a domain name;
comparing the domain name to the brand identifier;
in response to comparing the domain name to the brand identifier, determining that the domain name comprises the brand identifier or an imitation of the brand identifier;
in response to determining that the domain name comprises the brand identifier or the imitation of the brand identifier, transmitting a notification to the brand custodian;
receiving a response to the notification from the brand custodian; and
based on receiving the response to the notification from the brand custodian, rejecting or approving the domain name registration request.

11. The computer program product according to claim 10, wherein the response comprises an approval from the brand custodian.

12. The computer program product according to claim 11, wherein the domain name registration request is approved in response to receiving the approval from the brand custodian.

13. The computer program product according to claim 10, wherein the response comprises a rejection from the brand custodian.

14. The computer program product according to claim 13, wherein the domain name registration request is rejected in response to receiving the rejection from the brand custodian.

15. The computer program product according to claim 10, wherein validating the brand submission is based on analyzing documentary evidence provided by the brand custodian.

16. The computer program product according to claim 10, wherein validating the brand submission comprises determining that the brand custodian uses the brand identifier.

17. The computer program product according to claim 10, wherein validating the brand submission comprises determining that the brand custodian owns the brand identifier.

18. The computer program product according to claim 10, wherein the non-transitory computer-readable storage medium has computer-executable instructions for causing the computer processor to perform the steps of:
receiving a second domain name registration request for a second domain name;
comparing the second domain name to the brand identifier;
in response to comparing the domain name to the brand identifier, determining that the second domain name does not comprises or imitate the brand identifier; and
in response to determining that the domain name does not comprise or imitate the brand identifier, approving the domain name registration request.

19. A method for detecting and remediating invalid domain name registration requests, comprising:
receiving, via a computer processor, a brand submission from a brand custodian, the brand submission comprising a brand identifier;
validating, via a computer processor, the brand submission;
in response to validating the brand submission, storing, via a computer processor, a brand validation record in a brand database, the brand validation record comprising the brand identifier;
receiving, via a computer processor, a domain name registration request for a domain name;
comparing, via a computer processor, the domain name to the brand identifier;
in response to comparing the domain name to the brand identifier, determining, via a computer processor, that the domain name comprises the brand identifier or an imitation of the brand identifier;
in response to determining that the domain name comprises the brand identifier or the imitation of the brand identifier, transmitting, via a computer processor, a notification to the brand custodian;
receiving, via a computer processor, a response to the notification from the brand custodian; and
based on receiving the response to the notification from the brand custodian, rejecting or approving, via a computer processor, the domain name registration request.

20. The method according to claim 19, comprising:
receiving a second domain name registration request for a second domain name;
comparing the second domain name to the brand identifier;
in response to comparing the domain name to the brand identifier, determining that the second domain name does not comprises or imitate the brand identifier; and
in response to determining that the domain name does not comprise or imitate the brand identifier, approving the domain name registration request.
